(19) United States
(12) Patent Application Publication
(10) Pub. No.: US 2011/0278155 A1
(43) Pub. Date: Nov. 17, 2011

(54) ELECTROCHEMICAL CONTROL OF CHEMICAL CATALYSIS USING SINGLE MOLECULE MOTORS AND DIGITAL LOGIC

(75) Inventors: Daniel J. Friedman, Sleepy Hollow, NY (US); James R. Kozloski, New Fairfield, CT (US); Charles C. Peck, III, Newtown, CT (US); Stanislav V. Plonsky, Putnam Valley, NY (US); Ajay K. Royyuru, Congers, NY (US)

(73) Assignee: INTERNATIONAL BUSINESS MACHINES CORPORATION, Armonk, NY (US)

(21) Appl. No.: 12/779,318

(22) Filed: May 13, 2010

(51) Int. Cl. B01J 19/08; H05F 3/00

(52) U.S. Cl. 204/164

(57) ABSTRACT

Methods for controlling catalysis of a chemical reaction generally includes electrostatically controlling position of a first linear single-molecule polymer inside at least one nanopore fluidly coupled to a reaction chamber comprising a reaction medium and at least one reactant, wherein the first linear single-molecule polymer is coupled to a first catalyst at one end and includes one or more charged sub-units; and creating an electrostatic potential well inside the nanopore, wherein the electrostatic potential well controls a position of the first linear single-molecule polymer inside the at least one nanopore. Also disclosed are apparatuses for controlling catalysis of the chemical reaction.

### BACKGROUND

The present invention relates generally to electrochemical control of chemical catalysis using single motor molecule motors and digital logic. More particularly, the present disclosure relates to functionalized molecules for controlling catalysis within a nanopore.

The control of chemical reactions in solution is central to many industries. Positive and negative catalysts are often used to regulate rates of chemical reaction, often in sequences, to create desired products. These sequences have been controlled by sequestering the precursors, products, and catalysts in multiple large reaction chambers, wherein the three react freely in solution. The process of separating precursors from catalysts until some desired reaction time; separating products from the catalysts following reaction and before the next step in a sequence of reactions can be difficult and rather costly. Often the volumes used for effective use of multi-chamber sequestering methods are large, and therefore the use of costly precursors can be prohibitive and reaction/fabrication times maybe necessarily slow due to dilution of the se precursors. Of these costly intermediate steps, such as those to concentrate intermediate products, may also be required in order to ensure high yields. The problem then of easily controlling the physical sequestering of catalysis or temporarily disrupting function, within a single reaction chamber has economic consequences. Specifically, simple direct control of sequences of chemical reactions with a single reaction chamber using digital logic and programs to control catalysis directly would boost efficiencies and reduce costs of manufacturing products.

### SUMMARY

In an exemplary embodiment, a method for controlling catalytic activity of a chemical reaction comprises electrostatically controlling position of a first linear single-molecule polymer inside at least one nanopore fluidly coupled to a reaction chamber comprising a reaction medium and at least one reactant, wherein the first linear single-molecule polymer is coupled to a first catalyst at one end and includes one or more electrostatically controllable sub-units; and creating an electrostatic potential well inside the nanopore, wherein the electrostatic potential well controls a position of the first linear single-molecule polymer inside the at least one nanopore, thereby controlling the catalytic activity with position of the first linear single-molecule polymer.

In another embodiment, a method of catalyzing a reaction within a reaction chamber housing at least one reactant within a reaction medium, wherein the reaction chamber includes a plurality of nanopores comprises introducing linear single-molecule polymers into a plurality of nanopores fluidly coupled to the reaction chamber, wherein the linear single-molecule polymers are soluble in the reaction medium; coupling a catalyst to one end of the linear single-molecule polymers, wherein the linear single-molecule polymers include one or more charged sub-units; and electrostatically controlling a position of the linear single-molecule polymers coupled to the catalyst with an electric field applied to a channel defining each one of the plurality of nanopores to control a catalytic reaction of the at least one reactant, wherein the channel comprises alternating insulating and conductive layers.

### BRIEF DESCRIPTION OF THE SEVERAL VIEWS OF THE DRAWINGS

Referring to the exemplary drawings wherein like elements are numbered alike in the several Figures:

FIG. 1 schematically illustrates a cross sectional view of an exemplary catalyst control system according to one embodiment of the present invention;

FIG. 2 schematically illustrates a cross sectional view of an exemplary catalyst control system according to one embodiment of the present invention;

FIG. 3 is a diagram illustrating exemplary application of time dependent voltages system according to one embodiment of the present invention; and

FIG. 4 is flow diagram illustrating a process for controlling the position of a catalyst within a reaction chamber.

### DETAILED DESCRIPTION

Disclosed herein are methods and apparatuses for controlling catalytic activity within a reaction chamber. The methods generally include sequestering or deforming a catalyst using a single-molecule linear motor coupled to the catalyst. As used herein, the term “catalyst” is generally defined as a substance that increases the rate of a chemical reaction by reducing the activation energy. The catalyst is generally left unchanged after the reaction. In various embodiments herein, the catalyst can comprise one or more subunits such that controlling positions of the single-molecule linear motors is effective to differentially effect reactivity of the one or more subunits with a reactant.

The apparatuses for effecting sequestration or deformation of the catalyst generally include a nanopore formed within a metal dielectric sandwich, wherein the nanopore is fluidly coupled to a reaction chamber including at least one reactant. During use, the nanopore is bathed in a conductive solution that permeates the nanopore such that a voltage applied between each conductive layer of the metal dielectric sandwich can selectively create a heterogeneous electric field pattern within the nanopore. The heterogeneous electric field pattern can be then be used to modulate catalytic activity by direct sequestration or deformation of the catalyst. The apparatuses allow the end user to program specific catalysts and/or catalyst subunits at specific times to create digital logic control of a spatiotemporal sequence of chemical reactions within a single chamber.

In one embodiment, the single-molecule linear motor is a linear polymer comprising charged subunits (e.g., a phosphate group) that can diffuse into the nanopore. At least one end of the linear polymer is coupled or is configured to be coupled to a catalyst or catalyst subunit during use. The pattern of the electric field inside the nanopore can be matched to the charged subunits of the polymer such that the polymer can be selectively trapped and held in place or translocated into the reaction chamber. In this manner, polymers of different species and catalysts can be loaded into the nanopores either in series or batch. In series, specific nanopores can be loaded with specific polymers in a specific order by controlling the voltage. In batch mode, different polymers may be loaded in parallel and then subsequently identified by noting their properties and by sensing how they interact differently with the electric field within the nanopore. Finally, patterning of pores differently may allow batch loading of different polymers that match the electric field within the nanopore, i.e., functioning as a lock and key. With appropriate patterning, the field within the nanopore can be shaped to affect a linear motion of the polymer through the pore resulting in the polymer being trapped at another location along the polymer.

As discussed above, the polymer that defines the single-molecule linear motor can be physically (e.g., chemically) coupled to the specific catalyst prior to or after insertion into the nanopore. In this manner, the single-molecule motor can be used to control the location of the catalyst inside the nanopore containing the bathing medium. By allowing the nanopore of the motor, or a second retraction nanopore of the same or different caliber but contiguous with the motor's nanopore, to accommodate the catalyst, the catalyst may then be retracted into the retraction pore and rendered isolated from the bathing medium. If the bathing medium is the reaction solution, the effect is direct sequestering of the catalyst and isolation from the reaction chamber.

In one embodiment, the polymer comprises a long chain without branches or cross-linked structures. The polymer can be hydrophilic or hydrophobic depending on the intended application and reaction medium. Charged subunits such as phosphate ions, ammonium ions, and the like are provided such that the polymer can be electrostatically controlled upon application of an electric field. In the event the polymer molecules from a set of single-molecule linear motors are each coupled to the same catalyst prior to or after their insertion into the nanopore, multiple configurations of single-molecule motors along the sandwich and multiple positions of the polymers within the nanopores are possible. Each of these configurations then creates different forces at their points of attachment to the catalyst, thereby providing different levels of stress on the molecule. By modulating the stress on the molecule, different levels of modulation of the catalyst capacity of the catalyst or catalyst subunit can be achieved.

A program can be implemented to control catalysis of the chemical reaction using the single-molecule linear polymers. In this manner, different electrical field patterns can be stored that are tuned to specific polymers such that different nanopores can be logically utilized at the same or different steps of the chemical reaction. The polymer molecules can bear different patterns of charge along the length of the polymer; these patterns may be tuned to the electrical field pattern. Still further, multiple copies of the polymer molecules can be synthesized and assigned to a specific point of attachment to the catalyst, or to a specific catalyst or catalysts. The assignment of catalysts permits the catalysts to be addressed uniquely or in unique sets through the logical program's control of nanopores and their pattern matched polymers. By controlling the single-molecule linear polymers with an electrical field within the nanopores, the polymers may be stepped into and out of the nanopore in varying degrees.

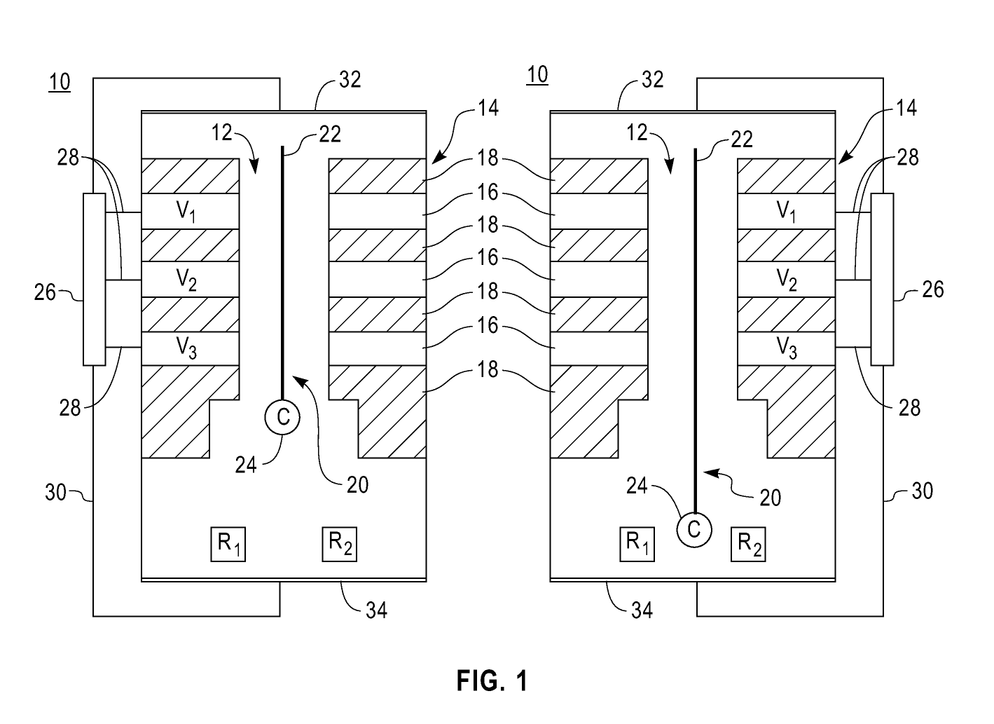

FIG. 1 schematically illustrates an apparatus 10 in accordance with one embodiment including at least one nanopore 12 within a metal dielectric sandwich 14 having alternating conductive 16 and insulating layers 18. The number of alternating conductive and insulating layers is not intended to be limited. The apparatus is configured to selectively sequester or deliver a catalyst or catalyst subunit within the nanopore 12 utilizing a single-molecule linear motor 20. The single-molecule linear motor 20 generally includes a linear polymer 22 soluble within the reaction medium, wherein the linear polymer is coupled to the catalyst 24 prior to or after insertion into the nanopore. The polymer 22 includes one or more charged subunits in an amount effective to be electrostatically controlled by an applied voltage to the conductive layers 16. The electrical potential (V₁, V₂, V₃) of each conductive layer, i.e., locking electrodes, is set independently by control unit 26. V₁, V₂, V₃ are the respective voltages for the depicted conductors 16. Also, the voltages connect to the conductive layers 16 via wires 28. Control unit 26 provides bias voltage via wire 30 to drag electrodes 32, 34.

During operation, the applied voltage to the conductive layers 16 can be in an amount effective to electrostatically retain or move the single-molecule linear motor such that the catalyst is either “hidden” from the reactants as shown on the left to inhibit catalytic reaction of reactants R₁ and R₂ or “active” to extend the catalyst into the nanopore to effect a catalytic reaction between reactants R₁ and R₂ to produce product. In one embodiment, the voltage difference of drag electrodes 32, 34 can be used to retain or advance the polymer within the nanopore 12. The control unit 26 can be configured to detect the polymer by measuring the ion current between electrodes 32, 34 or between electrodes 16 or between various combinations of the electrodes 16, 32, 34. Once the polymer is within the nanopore, the voltage between electrodes 32, 34 can be reduced and voltage applied to the electrodes 16 to create a potential well. The voltage applied to each one of the electrodes 16 can be varied.

The electrodes 16, 32, and 34 can be controlled independently or can be controlled in parallel. In addition, the electrodes 16, 32, or 34 can be made from a conductor, e.g., gold, copper, carbon, and the like. Still further, the various electrodes can have one or more geometry.

It should be appreciated, however, that other embodiments may include one or more control units. A control unit may include, for example, a computer that connects to a specialized board with an application-specific integrated circuit (ASIC), wherein the board connects to the device. A control unit may also, for example, be integrated with the device by way of a Nano-Electro-Mechanical System (NEMS), wherein a nanofluidics part (for example, a reservoir with DNA) can be combined with electronics (for example, a control unit). A control unit implements the step of applying time-dependent voltages to the drag electrodes 32, 34 to attract a linear charged polymer-catalyst molecule through the nanopores 12, as well as the step of applying a time-dependent voltage to each locking electrode 16 to create an electrostatic potential well, wherein the electrostatic potential well controls the position of the linear charged polymer-catalyst molecule.

Moreover, in an illustrative embodiment of the present invention, the control unit 26 implements the steps of detecting entry of the linear charged polymer-catalyst inside the nanopore, and reducing the time-dependent voltages from the drag electrodes. A control unit may also implement the steps of performing one or more characterization activities on a monomer of the linear charged polymer, reducing the time-dependent voltage from each locking electrode and the electrostatic potential well, and increasing or re-applying the time-dependent voltages to the drag electrodes to translocate the linear charge polymer-catalyst by zero, one, or more monomers.

Also, in one or more embodiments of the present invention, the control unit 26 may implement repetition of one or more actions. Such actions may include, for example, reducing or removing the time-dependent voltages from the drag electrodes, and increasing or re-applying the time-dependent voltage to each locking electrode to create an electrostatic potential well. Such repeated actions may also include, for example, performing one or more characterization activities on a monomer of the linear charged polymer, reducing or removing the time-dependent voltage from each locking electrode and the electrostatic potential well, and increasing or re-applying the time-dependent voltages to the drag electrodes to translocate the linear charge polymer by zero, one, or more monomers.

In an illustrative embodiment of the invention, the control unit 26 implements repetition of the above steps for an entire polymer.

As a prophetic example, consider the fabrication of a large polypeptide using native chemical ligation, which is a technique used for constructing a large polypeptide from two or more unprotected peptides. In native chemical ligation, a peptide containing C-terminal thioester reacts with another peptide containing an N-terminal cysteine in the presence of a catalyst. By coupling the three components of native ligation, the C-terminal thioester containing peptide, the N-terminal cysteine containing peptide and the thiol catalyst to a single molecule motor such as those previously described, the reaction can be digitally controlled. By creating an apparatus with multiple different C-terminal peptides and N-terminal cysteine peptides, each loaded sequentially or coupled to differently patterned polymers (and thus under independent control of the digital controller), different recombinant large polypeptide chains can be synthesized in the same chamber by varying the reaction sequence of the sub-peptides, depending on the desired sequence.

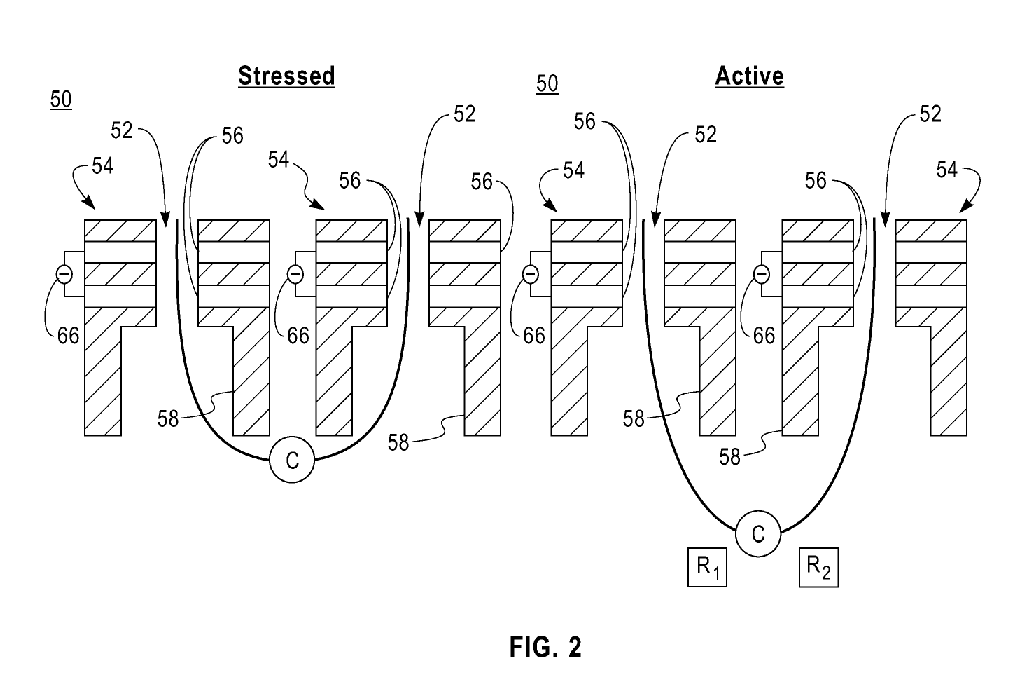

FIG. 2 schematically illustrates an apparatus 50 configured for selective deformation and translocation of a catalyst in accordance with another embodiment of the invention. The apparatus includes two or more contiguous metal dielectric sandwiches 54 (alternating conductive 56 and insulating layers 58), each one of which includes at least one nanopore 52 extending therethrough. The apparatus can be configured to translocate single-molecule linear motors, i.e., linear polymers including one or more charged sub-units, in parallel into the nanopore. The linear polymers are selected such that one end of the polymer can be coupled to the catalyst. The single-molecule linear polymer-catalyst can be prefabricated or may be formed in situ. A control unit 66 is configured to provide voltage to the conductive layers, i.e., locking electrodes, in the same manner as previously described. The drag electrodes (not shown, similar to that shown in FIG. 1) can be used to provide a bias to effect movement of the single-molecule linear polymer into the nanopore 52. In this embodiment, single-molecule linear polymer from different nanopores couple to the same catalyst. Once coupled, the voltage applied to the various electrodes is used to deform the catalyst as shown in the left side of FIG. 2, rendering the catalyst less active. The amount of deformation, i.e., stress, can be varied by altering the voltage. Alternatively, the control unit can be programmed to provide an electrical pattern that makes the catalyst more active as shown in the right side of FIG. 2.

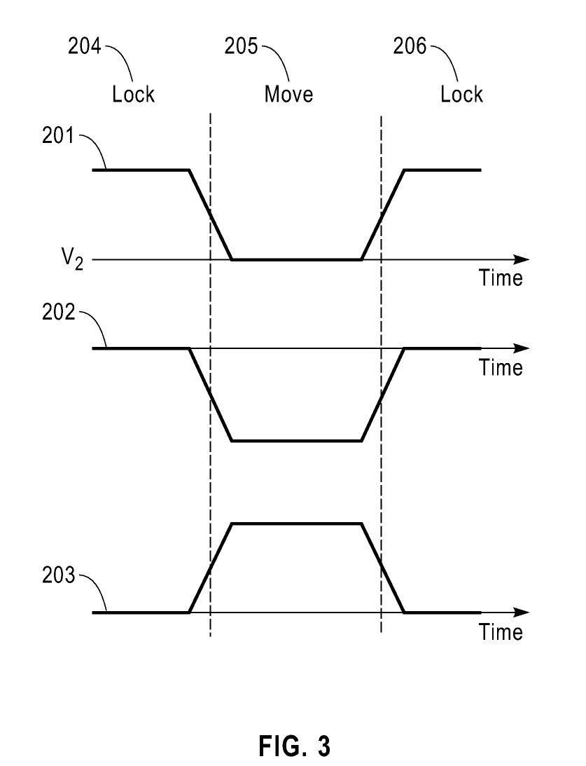

FIG. 3 is a diagram illustrating exemplary applications of time-dependent voltages according to an embodiment of the present invention. By way of illustration, FIG. 3 depicts three positions: a lock position 204, a move position 205 and a lock position 206. Moving a potential wave drags the one or more trapped charges, and stopping the wave localizes the one or more charges. FIG. 3 also depicts application of time-depiction voltages to three separate electrodes.

As illustrated in FIG. 1, an embodiment of the present invention includes two drag electrodes 32, 34 and three locking electrodes 16 with corresponding electrical potential (V₁, V₂ and V₃, respectively). In FIG. 3, an exemplary application of time-dependent voltages is depicted as occurring simultaneously for each drag electrode (202 and 203) as well as for the second or middle locking electrode (201), wherein the depicted time axes are shared. As way of example only, application of time-dependent voltages may proceed as follows. In 201, the voltage application (V₂) for the second or middle locking electrode may include 1 volt in lock position 204, 0 volts in move position 205, and 1 volt in lock position 206 (the first and third locking electrodes would have voltage levels that remain constant, i.e., V1 and V3=0). In 202, the voltage application for drag electrode 32 may include 0 volts in lock position 204, −1 volt in move position 205, and 0 volts in lock position 206. In 203, the voltage application for drag electrode 34 may include 0 volts in lock position 204, 1 volt in move position 205, and 0 volts in lock position 206.

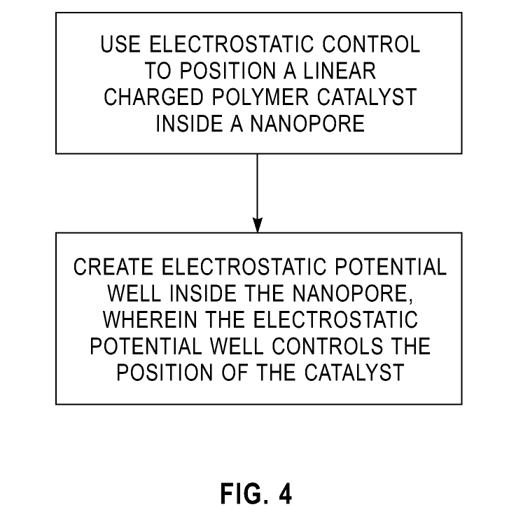

FIG. 4 is a flow diagram illustrating techniques for controlling the position of a linear charged polymer-catalyst molecule inside a nanopore, according to an embodiment of the present invention. Step 402 includes using electrostatic control to position the linear charged polymer-catalyst inside a nanopore. Step 404 includes creating an electrostatic potential well inside the nanopore, wherein the electrostatic potential well controls a position of the catalyst inside the nanopore. As such, the spatiotemporal location of the catalyst can be effectively controlled.

Advantageously, the present description provides means to control catalysis of a complex sequence of a chemical reaction in a single sealed chamber, i.e., without adding or removing components to the chamber such as additional reactions or catalysts. In addition, the present invention provides a means to program spatiotemporal sequence of chemical reactions using digital logic coupled to a set of single molecule motors comprising nanopores within metal dielectric sandwiches. Still further, present invention provides a means to selectively couple catalysts to other patterned polymer molecules rendering these molecules addressable by digital means. As described above, the polymer conjugates can be prefabricated as may be desired for different application, thereby providing an end-user with the proprietary components of a digital chemistry apparatus. The present invention also provides a means to modulate and achieve intermediate states using unique patterns of stresses on the catalyst.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for controlling catalytic activity of a chemical reaction comprising:
electrostatically controlling position of a first linear single-molecule polymer inside at least one nanopore fluidly coupled to a reaction chamber comprising a reaction medium and at least one reactant, wherein the first linear single-molecule polymer is coupled to a first catalyst at one end and includes one or more electrostatically controllable sub-units; and
creating an electrostatic potential well inside the nanopore, wherein the electrostatic potential well controls a position of the first linear single-molecule polymer inside the at least one nanopore, thereby controlling the catalytic activity with position of the first linear single-molecule polymer.

2. The method of claim 1, wherein the first linear single-molecule polymer is coupled to the first catalyst prior to insertion into the at least one nanopore.

3. The method of claim 1, wherein the first linear single-molecule polymer is coupled to the first catalyst after insertion into the at least one nanopore.

4. The method of claim 1, wherein electrostatically controlling position of the first linear single-molecule polymer inside the at least one nanopore comprises translocating the first linear single-molecule coupled to the first catalyst into the reaction chamber, wherein the first catalyst is effectively positioned to effect a catalytic reaction with the at least one reactant

5. The method of claim 1, wherein electrostatically controlling position of the first linear single-molecule polymer inside the at least one nanopore comprises holding the first linear single-molecule coupled to the first catalyst within the at least one nanopore to prevent a catalytic reaction of the at least one reactant disposed within the reaction chamber.

6. The method of claim 1, wherein electrostatically controlling position of the first linear single-molecule polymer inside the at least one nanopore comprises holding the first linear single-molecule coupled to the first catalyst within the at least one nanopore to render the catalyst less reactive with the at least one reactant disposed within the reaction chamber.

7. The method of claim 1, wherein electrostatically controlling position of the first linear single-molecule polymer comprises applying or altering a voltage applied to one or more conductive layers in a metal-dielectric sandwich, wherein the nanopore provides a fluid opening in the metal-dielectric sandwich.

8. The method of claim 1, further comprising at least one additional linear single-molecule polymer coupled to the first catalyst, wherein electrostatically controlling position of the linear single-molecule polymer and the at least one additional linear single-molecule polymer coupled to the first catalyst is effective to make the catalyst less active.

9. The method of claim 1, further comprising at least one additional linear single-molecule polymer coupled to the first catalyst, wherein electrostatically controlling position of the linear single-molecule polymer and the at least one additional linear single-molecule polymer coupled to the first catalyst is effective to make the catalyst more active.

10. The method of claim 1, further comprising at least one additional catalyst that is different from the first catalyst.

11. The method of claim 8, wherein the at least one additional linear single-molecule is different from the first linear single-molecule polymer.

12. The method of claim 9, wherein the at least one additional linear single-molecule is different from the first linear single-molecule polymer.

13. The method of claim 1, further comprising at least one additional linear single-molecule polymer coupled to the at least one additional catalyst, wherein the at least one additional catalyst is the same as the first catalyst.

14. The method of claim 1, further comprising at least one additional linear single-molecule polymer coupled to the at least one additional catalyst, wherein the at least one additional catalyst is different from the first catalyst.

15. The method of claim 13, further comprising at least one additional linear single-molecule polymer is different from the first catalyst additional linear single-molecule polymer.

16. The method of claim 14, further comprising at least one additional linear single-molecule polymer is different from the first catalyst additional linear single-molecule polymer.

17. A method of catalyzing a reaction within a reaction chamber housing at least one reactant within a reaction medium, wherein the reaction chamber includes a plurality of nanopores, comprising:
introducing linear single-molecule polymers into a plurality of nanopores fluidly coupled to the reaction chamber, wherein the linear single-molecule polymers are soluble in the reaction medium;
coupling a catalyst to one end of the linear single-molecule polymers, wherein the linear single-molecule polymers include one or more charged sub-units; and
electrostatically controlling a position of the linear single-molecule polymers coupled to the catalyst with an electric field applied to a channel defining each one of the plurality of nanopores to control a catalytic reaction of the at least one reactant, wherein the channel comprises alternating insulating and conductive layers.

18. The method of claim 17, wherein at least a portion of the linear single-molecule polymers have different charged sub-units that respond differently to the electric field.

19. The method of claim 17, wherein introducing the linear single-molecule polymers is in parallel.

20. The method of claim 17, wherein introducing the linear single-molecule polymers is in series.

21. The method of claim 17, wherein electrostatically controlling the position of the linear single-molecule polymers coupled to the catalyst comprises applying one or more electric field patterns tuned to particular charged sub-units of the linear single-molecule polymer.

22. The method of claim 17, wherein electrostatically controlling the position of the single-molecule polymers coupled to the catalyst is time dependent.

23. The method of claim 17, wherein electrostatically controlling the position of the linear single-molecule polymers comprises applying an electric field effective to position the catalyst from reacting with the at least one reactant.

24. The method of claim 17, wherein electrostatically controlling the position of the linear single-molecule polymers comprises applying an electric field effective to position the catalyst to catalytically react with the at least one reactant to produce a product.

25. The method of claim 17, wherein coupling the catalyst to one end of the linear single-molecule polymers is in situ.

26. The method of claim 17, wherein electrostatically controlling the position of the linear single-molecule polymers coupled to the catalyst with an electric field to control the catalytic reaction comprises digitally controlling voltages within the nanopore applied to the reaction medium.

27. The method of claim 17, wherein electrostatically controlling the position of the linear single-molecule polymers comprises applying one or more electric field patterns stored within a digital controller coupled to the channel and tuned to particular charged sub-units of the linear single-molecule polymer, wherein the digital controller applies voltages to the channel to control the positions of the linear single-molecule polymers.

28. The method of claim 17, wherein electrostatically controlling the position of the linear single-molecule polymers comprises applying one or more electric field patterns tuned to particular charged sub-units of the linear single-molecule polymer at a particular time to create a spatiotemporal sequence of chemical reactions.

29. The method of claim 17, wherein the linear single-molecule polymers comprise more than one species, wherein the more than one species have different charged sub-units that behave differently to the electric field applied to the channel.

30. The method of claim 17, wherein the catalyst comprises at least one sub-unit coupled to the one end of the linear single-molecule polymers, and wherein electrostatically controlling the position of the linear single molecule polymers is effective to differentially effect reactivity of the at least one catalyst sub-unit with the at least one reactant.
